(19) United States
(12) Patent Application Publication
(10) Pub. No.: US 2024/0370944 A1
(43) Pub. Date: Nov. 7, 2024

(54) DIGITAL SOCIAL NETWORKING FRAMEWORK

(71) Applicant: Meta Platforms, Inc., Menlo Park, CA (US)

(72) Inventors: Shabnum Gulati, New York, NY (US); Oluwakayode M. Ajimatanrareje, JR., Fremont, CA (US); Jordan Springstroh, Austin, TX (US); Trevor Nesbitt, Redwood City, CA (US)

(21) Appl. No.: 18/310,127

(22) Filed: May 1, 2023

(51) Int. Cl. G06Q 50/00

(52) U.S. Cl. CPC G06Q 50/01

(57) ABSTRACT

The disclosed systems and methods may include (1) receiving, from a user who has a dating account with a dating application maintained by a social media platform, user input designating a contact of the user, connected to the user via the social media platform, as a matchmaker for the dating account and (2) in response to receiving the user input designating the contact as a matchmaker for the dating account, providing the contact with access to a recommended-matches interface of the dating application, comprising a queue of recommended dating matches selected for the user, in a matchmaker mode that enables the contact to perform one or more digital matchmaking actions. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method relating to a digital social networking framework.

FIG. 2 is a block diagram of an exemplary system for a digital social networking framework.

FIG. 3 is an illustration of an exemplary newsfeed interface provided as part of a digital social networking framework.

FIG. 4 is an illustration of an exemplary digital stories interface provided as part of a digital social networking framework.

FIG. 5 is an illustration of an exemplary messaging interface provided as part of a digital social networking framework

FIG. 6 is an illustration of an exemplary short-form video consumption interface provided as part of a digital social networking framework.

FIG. 7 is an illustration of an exemplary media conferencing interface provided as part of a digital social networking framework.

FIG. 8 is an illustration of an exemplary interface that enables a user of a digital dating service to edit the user's profile.

FIG. 9 is an illustration of the exemplary interface that enables a user of a digital dating service to add a matchmaker to the user's account.

FIG. 10 is an illustration of an interface that enables a user of a digital dating service to assign a role to a contact designated as a matchmaker for the user's dating account.

FIG. 11 is an illustration of an exemplary notifications interface that notifies a user of having been added as a matchmaker to another user's dating account.

FIG. 12 is an illustration of an exemplary welcome interface presented to a user being added as a matchmaker to another user's dating account.

FIG. 13 is an illustration of an exemplary recommended-matches interface configured for a user of a dating application.

FIG. 14 is an illustration of an exemplary suggested-matches digest interface.

FIG. 15 is an illustration of an exemplary recommended-matches interface configured for a user designated as a matchmaker.

FIG. 16 is an illustration of an interface flow, for a digital vibe check process, presented to a user who initiated the vibe check process.

FIG. 17 is an illustration of an interface flow, for the digital vibe check process illustrated in FIG. 16, presented to a contact of the user initiating the vibe check process.

FIGS. 18-19 are illustrations of an exemplary interface flow corresponding to a group streaming space corresponding to a user's dating account.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to a digital social media framework that includes a dating service. In some examples, the dating service may include a feature that enables a user of a dating application (the “dater”) to assign a matchmaker designation to a contact (the “matchmaker”). The matchmaker designation may enable the matchmaker to access the dater's dating account in a matchmaker mode that allows the matchmaker to (1) view the dater's queue of platform-recommended dating matches, (2) conditionally accept or reject platform-recommended dating matches, and/or (3) annotate the profile cards of platform-recommended dating matches. The matchmaker's conditional accepting or rejecting may be presented to the dater for final approval (e.g., along with the matchmaker's annotations). In some examples, the matchmaker's conditional accepting or rejecting may be visually indicated to the dater within the profile cards of the dater's recommended dating matches. For example, a recommended dating match accepted by a matchmaker named Trevor may be presented to the dater within a profile card that includes a banner that says “Trevor Recommended.” In some examples, recommended dating matches conditionally accepted by the dater's matchmakers may be presented in a digest of matchmaker-suggested matches.

In some examples, a profile card of a platform-recommended dating match may be associated with a matchmaker chat thread, which may be presented in response to designated user input to the profile card. The matchmaker chat thread may enable the dater and the matchmaker to exchange messages relating to the profile card.

In some examples, the disclosed framework may enable the dater to assign different roles (e.g., permissions) to the matchmaker, such as a swiper role (e.g., that enables a matchmaker to conditionally accept or reject a recommended dating match on the dater's behalf), a conversationalist role (e.g., that enables a matchmaker to conditionally message with the dater's dating matches), and/or a profile editor role (e.g., that enables the matchmaker to conditionally edit the dater's dating profile).

In examples in which the disclosed dating service is part of a broader social media platform (e.g., that provides multiple services including the dating service), the contact designated as a matchmaker may have an account with the social media platform but may not be registered with (e.g., have an account with) the dating service. In some such examples, the contact may receive a notification of having been added as a matchmaker to the dater's account and may be invited to create a matchmaker account with the dating service.

In some examples, the disclosed dating service may include a feature that enables a dater to send the profile of a recommended dating match (presented to the dater) to a friend (e.g., a designated matchmaker) or group of friends for input (e.g., prior to accepting or rejecting the recommended dating match). In one such example, the profile card of a recommended dating match may include an element (e.g., a digital heart) that (1) triggers the recommended match to be accepted when the element is tapped but that (2) triggers the potential match to be sent to a friend (e.g., as a “vibe check) when a long-press is applied to the element. In some examples, content from the profile card may be sent to the friend or group of friends as an automatically generated private ephemeral story. The story may enable viewer input (e.g., voting) and may show the dater the results of the viewer input.

In some examples, the disclosed dating service may host a group streaming space that may enable digital communication (e.g., synchronous and/or asynchronous) relating to a dater's dating matches. In some examples, the group streaming space may be configured as a persistent space (e.g., a digital “Matchmaker Hub”). In one embodiment, an interface (e.g., corresponding to a digital messaging thread and/or a recommended dating match) may include an element (e.g., a “Date Together” element) that, when selected, generates a group streaming space (e.g., that presents an interface from a dater's dating account to the other users of the group for co-viewing). In some examples, the dater (whose account is on display via the group streaming space) may be enabled to give another user in the group navigational control. In one such example, a cursor, displayed to each participant of the group streaming space, may be configured as a circular element that displays the profile image of the user currently in control.

As will be explained in greater detail below, embodiments of the present disclosure may improve the field of social networking by improving data culling, data organization, data access, and data discovery. Embodiments of the present disclosure may improve a computer itself by improving data consumption flows and data organization.

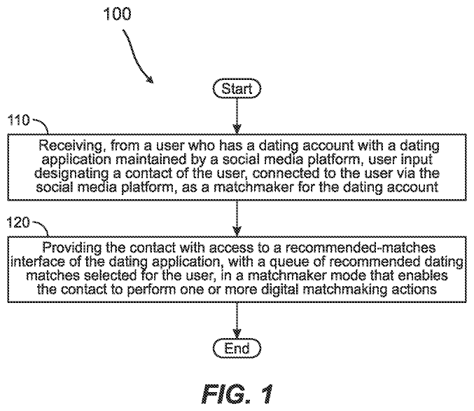

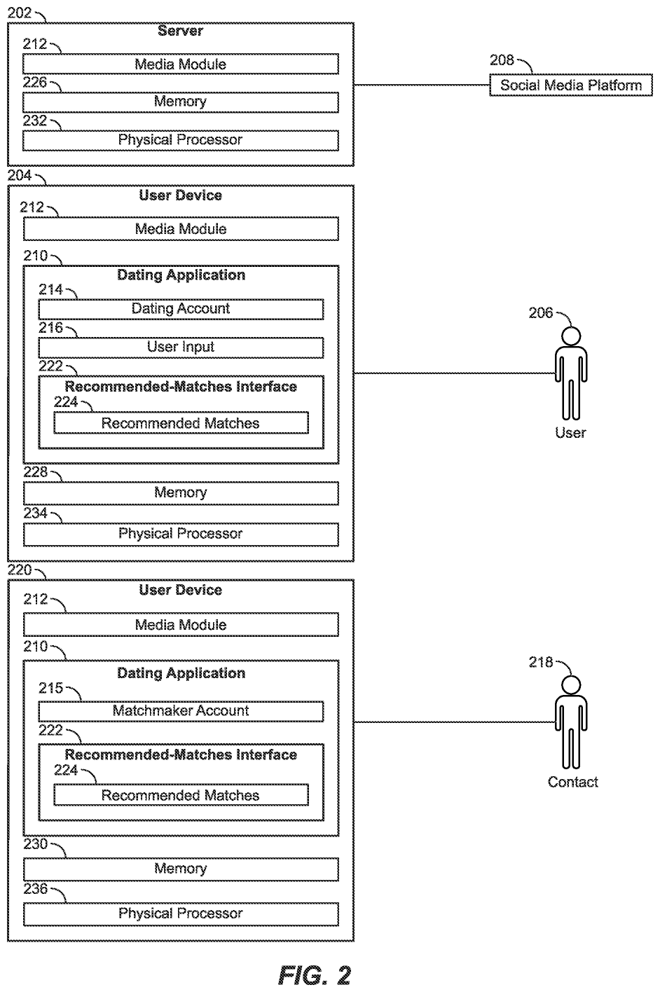

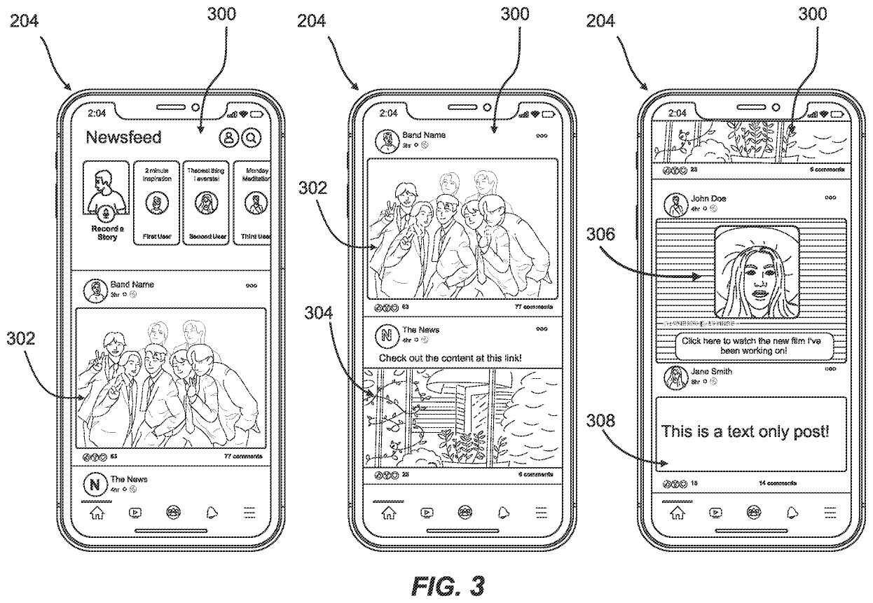

The following will provide, with reference to FIG. 1, detailed descriptions of computer-implemented methods relating to a social media framework. Detailed descriptions of corresponding example systems will also be provided in connection with FIG. 2. Detailed descriptions of interfaces and embodiments corresponding to the disclosed methods and systems will be provided in connection with FIGS. 3-19.

FIG. 1 is a flow diagram of an exemplary computer-implemented method 100 relating to a social media framework. The steps shown in FIG. 1 may be performed by any suitable computer-executable code and/or computing system, including the system(s) illustrated in FIG. 2. For example, the steps shown in FIG. 1 may be performed by modules operating in a server 202 and/or modules operating in a user device such as a user device 204 associated with a user 206. In one example, each of the steps shown in FIG. 1 may represent an algorithm whose structure includes and/or is represented by multiple sub-steps, examples of which will be provided in greater detail below.

Server 202 generally represents any type or form of backend computing device that may perform one or more functions directed at social networking. The term “social networking” may refer to any type or form of digital communication that occurs between users of a social networking platform via an interface of the social networking platform. Examples of social networking may include, without limitation, text-based and/or image-based communication, video-based communication, audio-based communication, videoconferencing and/or audioconferencing, digital status broadcasting, private digital messaging, public content posting and/or commenting via a social media feed and/or a profile, etc. In some examples, server 202 may operate as part of and/or in connection with a social media platform 208. Although illustrated as a single entity in FIG. 2, server 202 may include and/or represent a group of multiple servers that operate in conjunction with one another.

User device 204 generally represents any type or form of computing device capable of reading computer-executable instructions. For example, user device 204 may represent a smart phone and/or a tablet. Additional examples of user device 204 may include, without limitation, a laptop, a desktop, a wearable device, a personal digital assistant (PDA), etc.

In some examples, user 206 of user device 204 may be a user (e.g., a member) of a social networking platform (e.g., social media platform 208). In these examples, user device 204 may have installed an instance of a social media application (e.g., a dating application 210), which may operate as part of social media platform 208 and through which one or more services provided by social media platform 208 (e.g., via server 202) may be accessible. In some examples, the social media application may be dedicated to a single service. For example, the social media application may represent a dedicated dating application. In other examples, the social media application may provide access to multiple services (e.g., a combination of two or more of the social networking services described below). In addition, or as an alternative, to a social media application, user device 204 may have installed a browser that may navigate to one or more webpages through which the one or more services provided by social media platform 208 (e.g., via server 202) may also be accessible.

In some examples, the steps shown in FIG. 1 may be performed (at least in part) by modules operating in an additional user device (e.g., a device used by a contact of user 206 who has been designated as a matchmaker, as will be described in greater detail below in connection with steps 110-120). In these examples, the additional user device may include any of the features described above in connection with user device 204 and may have installed an additional instance of the social media application described above, which may operate as part of social media platform 208 and through which one or more services provided by social media platform 208 (e.g., via server 202) may be accessible.

As mentioned above, social media platform 208 may provide a variety of services (e.g., platforms and/or frameworks) for the users within its network (e.g., via server 202 and/or dating application 210). In one embodiment, social media platform 208 may provide a dating service that enables users to view and/or connect with potential dating matches (e.g., recommended dating matches). The dating service may select potential dating matches for a user (e.g., algorithmically) using any type or form of recommended match selection system. In some examples, the dating service may enable a user to create a digital dating profile. The digital dating profile may be presented to additional users of the dating service (e.g., within a digital profile card) for whom the user has been selected as a potential dating match. Additionally, the digital dating profiles of the additional users may be presented to the user (e.g., where each digital dating profile is presented in a different digital profile card).

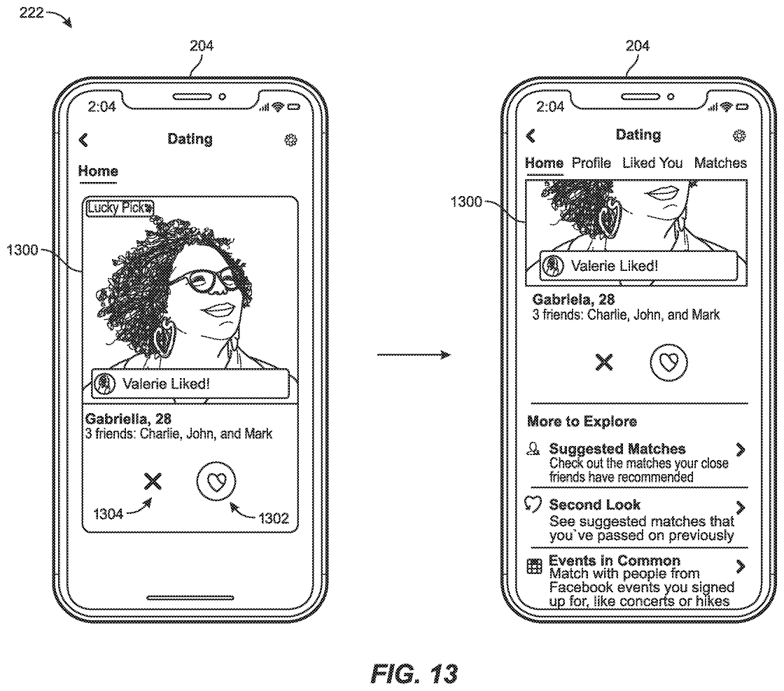

Upon presenting a user with a potential dating match, the dating service may enable the user to digitally accept or reject the potential dating match. If the user digitally accepts a potential dating match corresponding to an additional user who has also accepted the user as a potential dating match (a mutual match), both users may be notified of the same. In some examples, a mutual match may enable additional user action (e.g., may enable messaging between the two users). FIG. 13 (which will be described in greater detail below in connection with step 120) depicts an exemplary potential dating match presented within a profile card to user 206. Additional dating service features will be described below (e.g., in connection with steps 110 and 120 of FIG. 1).

In addition to a dating service, social media platform 208 may provide a variety of additional services (e.g., each of which may be integrated with the dating service). In some examples, social media platform 208 may provide a newsfeed service. The term “newsfeed” may generally refer to any type or form of social media consumption channel, provided via an interface, that presents a scrollable collection of newsfeed posts. In some examples, a newsfeed may scroll (e.g., upward or downward) to reveal the different posts within the newsfeed (e.g., in response to receiving user scrolling input). In one example, the scrollable collection may include newsfeed posts created by contacts of a particular user (e.g., friends of the particular user) and/or other users that the particular user is following (i.e., connected content). Additionally, the newsfeed may include non-connected content (e.g., content created by users who are not contacts of the particular user).

The term “newsfeed post” generally refers to any type or form of digital composition that may be displayed in a newsfeed. Newsfeed posts may include a variety of content. For example, a newsfeed post may include, without limitation, text, an image, a video, a set of multiple images and/or videos, and/or a link (e.g., to a post, webpage, article, film, etc.). FIG. 3 depicts an exemplary newsfeed interface 300 with a newsfeed that includes an image-based newsfeed post 302, a link-based newsfeed post 304, a video-based newsfeed post 306, and a text-based newsfeed post 308.

In some examples, a newsfeed post may include a viewing pane for the content of the newsfeed post (e.g., the text in a text-based post, the image in an image-based post, etc.). A newsfeed post may also display a text-based caption, metadata content (e.g., content describing users that have been tagged in the newsfeed post, a timestamp, etc.), information indicating the source of the newsfeed post (e.g., the name of the creator of the post, a profile image, etc.), and/or a digital special effect (e.g., a digital sticker, a filter, an-augmented reality element, etc.). Such information and/or features may be displayed (and/or a menu corresponding to such information and/or features may be displayed) within the viewing pane (e.g., over the primary content), within the viewing pane and/or may be visually associated with the viewing pane (e.g., displayed beneath the viewing pane).

The newsfeed service may enable viewers of a newsfeed post to digitally respond to the newsfeed post in a variety of ways. In some examples, a newsfeed interface may enable a user to comment on a newsfeed post (e.g., via a text, image, and/or video-based reply) and may create a digital thread of comments corresponding to the newsfeed post (e.g., displayed beneath the newsfeed post and/or accessible via a comments affordance).

As another example, social media platform 208 may provide a digital stories service. The digital stories service may provide users with a digital stories feed, which presents a continuous series of digital story posts to a story-consumer, one by one (e.g., in a slideshow format). The term “digital story post” may generally refer to any type or form of digital composition intended for a digital stories feed. A digital story post may include a variety of content (e.g., a digital photograph, a graphic, text, a digital video, an artificial reality element, a digital audio recording, etc.). In one example, the story consumption channel may transition from presenting one digital story post to the next automatically, without requiring any user input to do so. In some examples, digital story posts from the same source (e.g., created and/or posted by the same user) may be grouped together, such that each digital story post from a particular source is displayed prior to displaying digital story posts from another source.

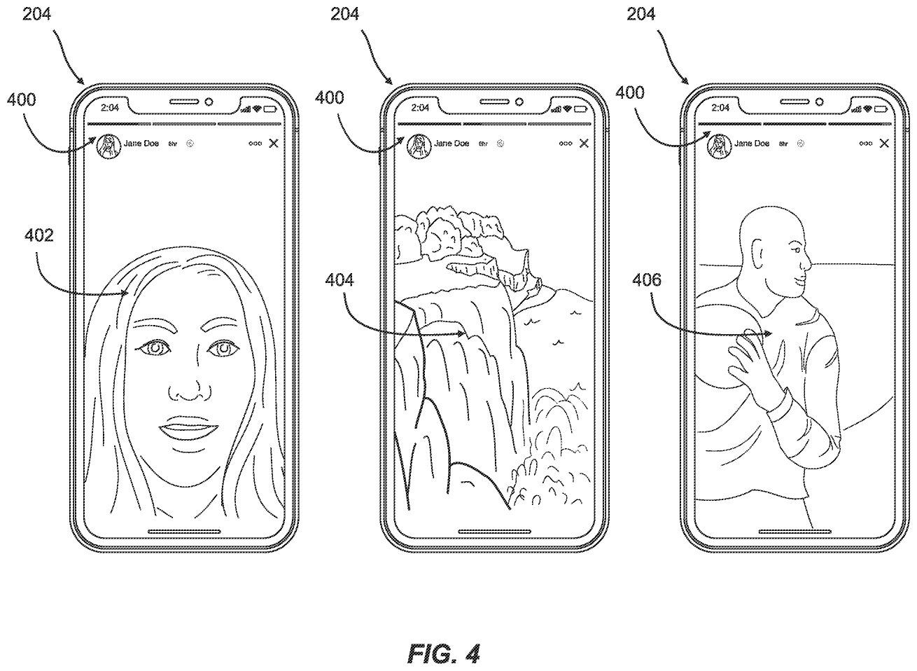

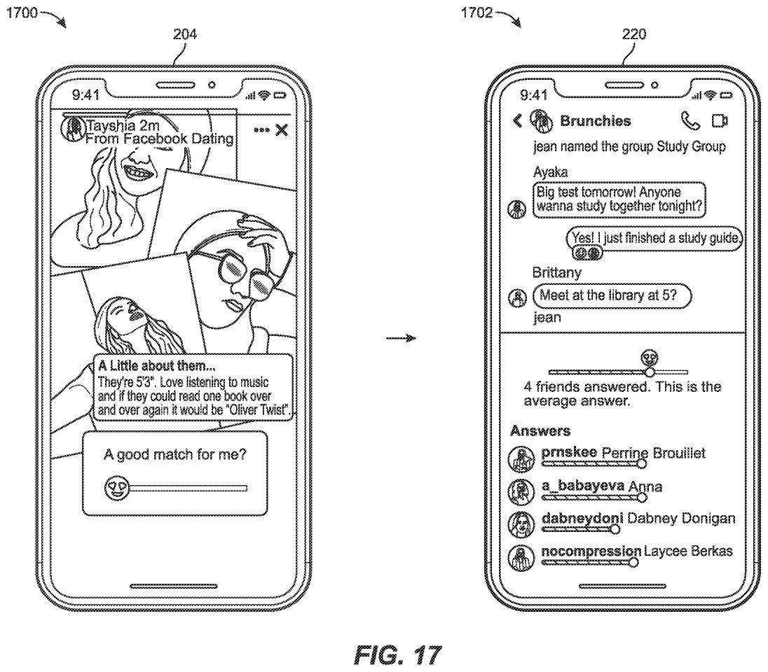

In one embodiment, a digital story post may be ephemeral. That is, the digital story post may only be viewable for a predetermined amount of time. For example, a digital story post may be set to disappear after twenty-four hours. Similar to the newsfeed service, the digital stories service may enable viewers of a story post to comment on the post, via a text and/or image-based reply and/or reply story, creating a digital thread of comments. Also similar to the newsfeed service, the digital stories service may configure a story feed for a particular user that includes connected content (e.g., story posts created by users who are contacts of the particular user or being followed by the particular user), non-connected content, or a determined ratio of connected content to non-connected content. FIG. 4 depicts an exemplary story interface 400 showing digital story posts 402, 404, and 406 of a user's digital story. FIG. 17 (which will be described in greater detail below) depicts an exemplary interface of the stories service integrated with the dating service.

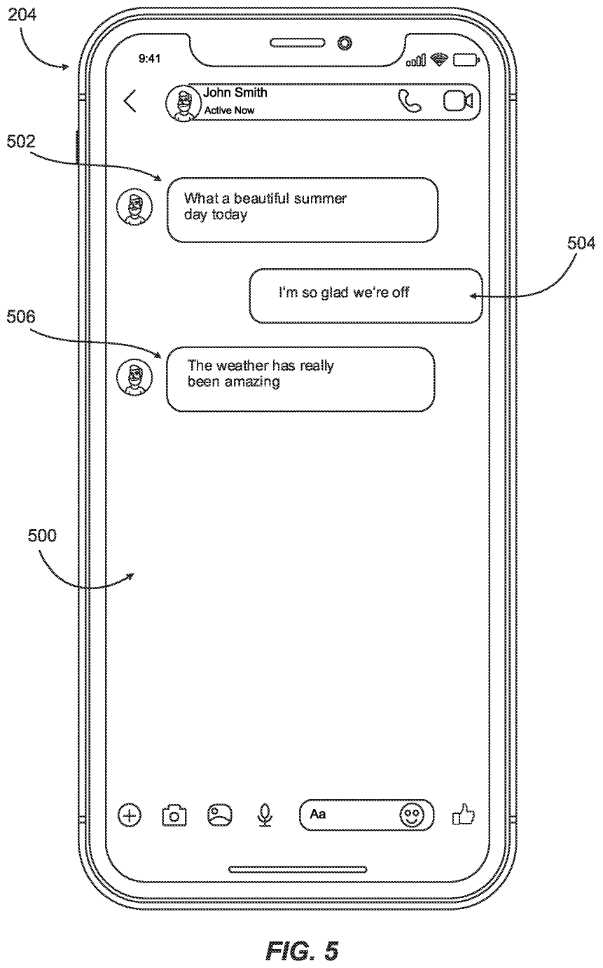

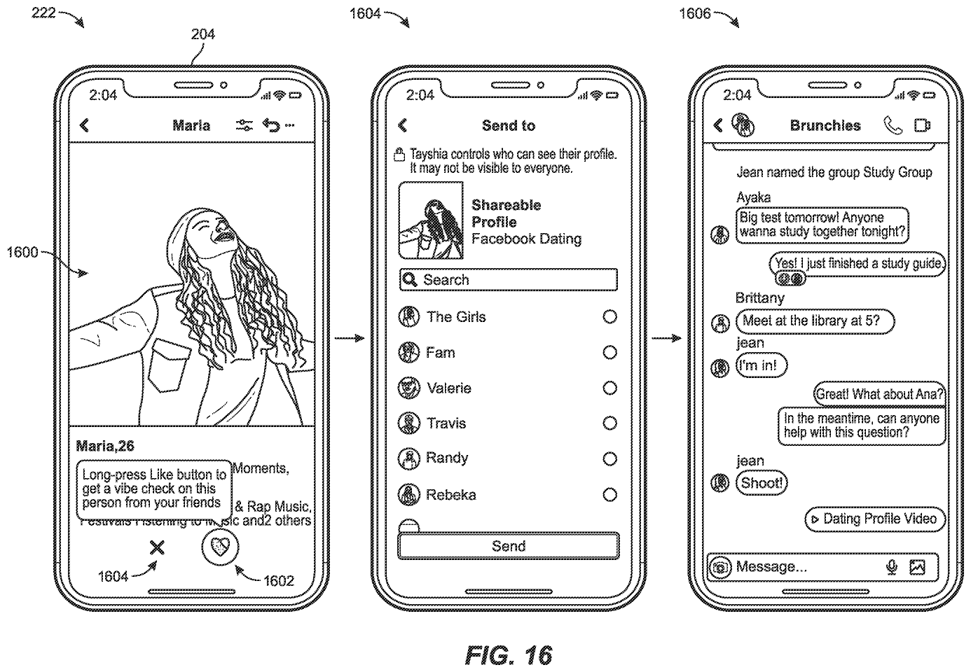

As another example, social media platform 208 may provide a messaging service. The term “messaging service” may generally refer to any type or form of digital message delivery system that enables users of social media platform 208 to exchange messages (e.g., text messages, audio messages, and/or video messages). FIG. 5 depicts an exemplary messaging interface 500 showing digital message posts 502, 504, and 506 of a digital messaging thread. FIG. 16 (which will be described in greater detail below) depicts an exemplary interface of the messaging service integrated with the dating service.

In some examples, social media platform 208 may provide a short-form video service (e.g., a reels service) that enables users to create short-form videos and/or consume (e.g., watch and/or digitally respond to) short-form videos created by other users. In one embodiment, social media platform 208 may create a short-form video feed for each user of its short-form video service. The term “short-form video” may generally refer to a digital video configured for short-form video feed consumption. In some examples, a platform for creating and/or posting a short-form video may only enable the creation and/or posting of short-form videos that are a certain length and/or that are less than a certain length (e.g., less than thirty seconds in length).

The term “short-form video feed” may generally refer to a series (e.g., a queue) of digital short-form videos (e.g., selected for a particular user) that a social media application (or a corresponding webpage) is configured to play, one by one, as a continuous series (e.g., advancing from one short-form video to the next automatically). In some examples, a short-form video feed may be configured to play short-form videos asynchronously (e.g., to play a continuously evolving queue of pre-recorded short-form videos). In some examples, short-form videos may be continuously added to a user's short-form video feed as the short-form videos of the feed are consumed (e.g., such that a determined number of short-form videos are always in queue to be played).

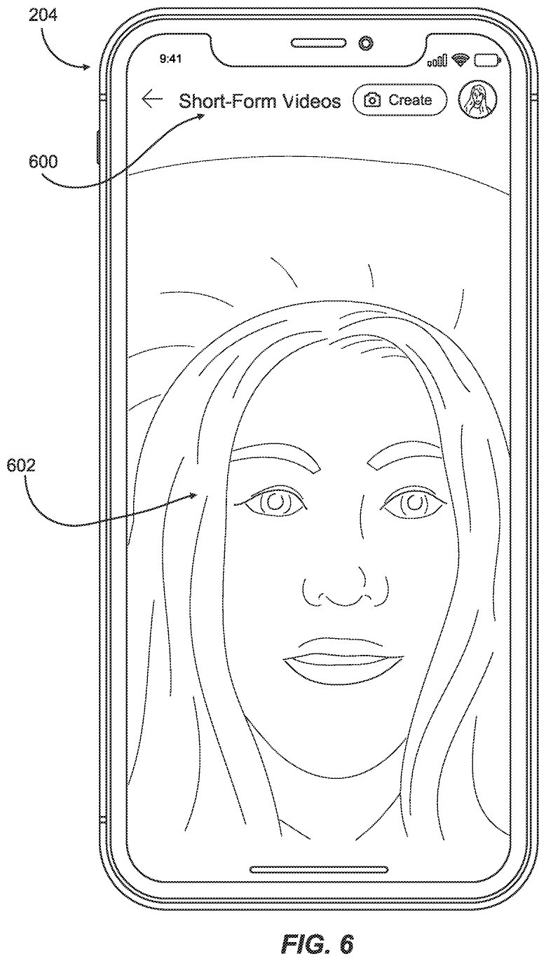

In some examples, a short-form video feed may be presented via a dedicated short-form video feed interface. FIG. 6 depicts an exemplary dedicated short-form video feed interface 600 presenting a short-form video 602. Short-form videos may be selected for the short-form video feed of a particular user based on a variety of metrics. For example, a short-form video may be selected based on a topic the short-form video has been tagged with (e.g., in response to a determination that the particular user is interested in and/or predicted to be interested in the topic). As another example, a short-form video may be selected based on a user who created the short-form video (e.g., in response to a determination that the particular user is following the user and/or is predicted to be interested in content by the creator). As another example, a short-form video may be selected based on a popularity of the short-form video.

In some embodiments, a short-form video may be displayed (e.g., streamed) with a variety of information relating to the short-form video. Such information may include, for example, a name and/or profile element of an account that created the short-form video, a title of the short-form video, viewer responses to the short-form video and/or an affordance that navigates to viewer responses to the short-form video, one or more elements for providing a digital social response to the short-form video, a transcript of the short-form video, etc.

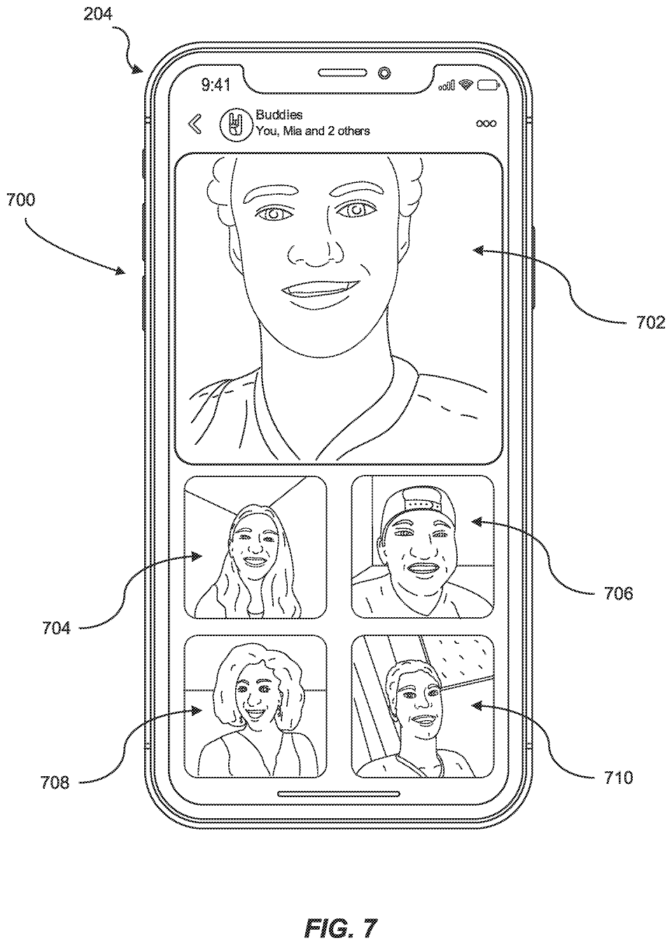

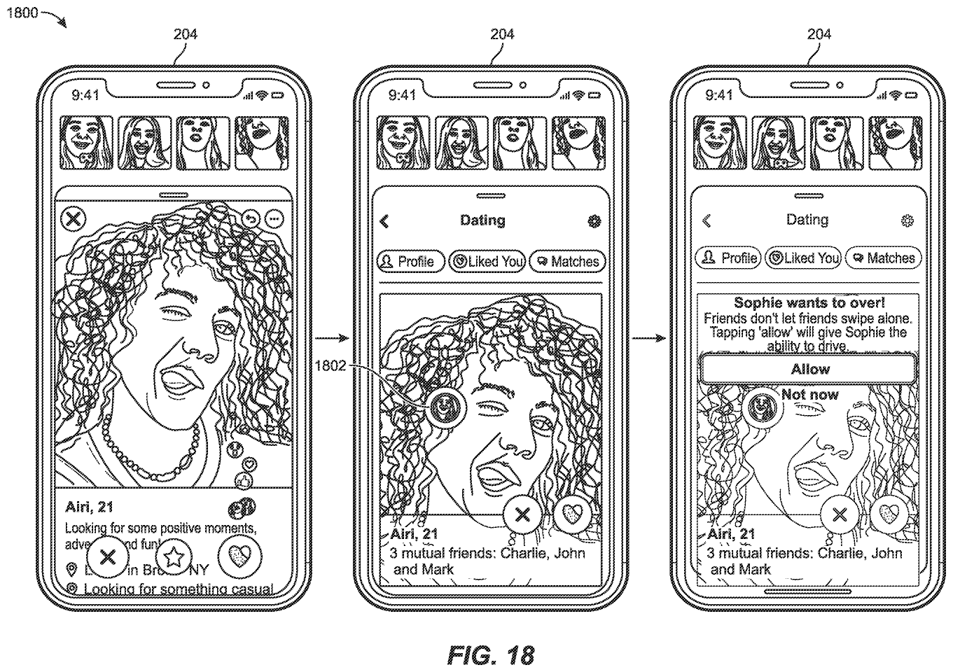

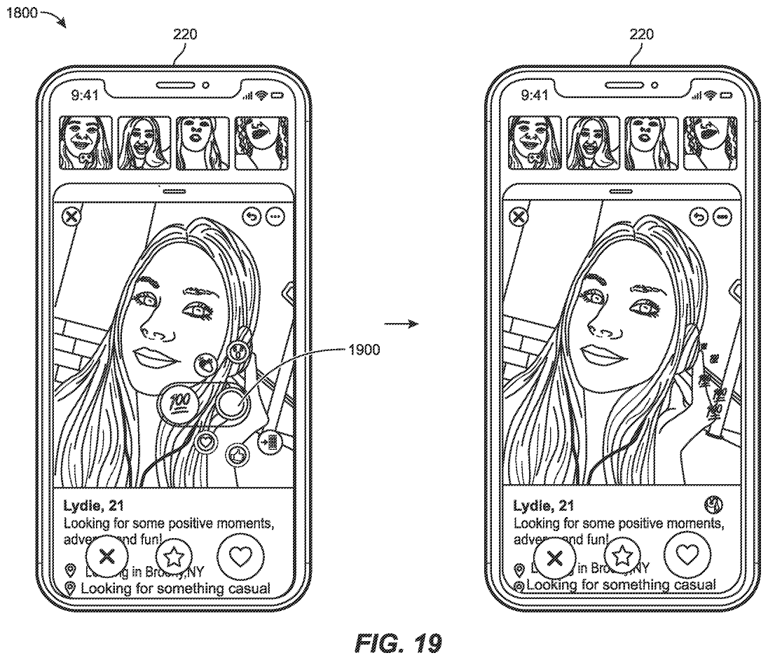

As another example, social media platform 208 may provide a media conferencing (e.g., audioconferencing and/or videoconferencing) service (e.g., a “rooms” service) for hosting media calls (e.g., audio calls and/or video calls). The media conferencing service may operate as a stand-alone service and/or may be integrated with another service (e.g., a messaging service, a social workplace service, etc.). The term “media conferencing service” refers to any type or form of streaming and/or videotelephony service that enables the digital transmission and/or sharing of real-time media (e.g., video and/or audio) streams (e.g., from multiple endpoints) via a media conferencing interface. The term “real-time media stream” generally refers to any type or form of multimedia that is transmitted in real time (e.g., as a series of frames) from an endpoint (i.e., a transmitting device) to one or more additional endpoints. Audio and/or frames may be played and/or displayed by an endpoint (to a user) as the audio and/or frames are received. FIG. 7 depicts an exemplary videoconferencing interface 700 with video tiles 702, 704, 706, 708, and 710 (each presenting a video stream of a user). FIGS. 18 and 19 (which will be described in greater detail below) depicts an exemplary interface of the media conferencing service integrated with the dating service.

Returning to FIG. 1, at step 110, one or more of the systems described herein may receive, from a user who has a dating account with a dating application maintained by a social media platform, user input designating a contact of the user, connected to the user via the social media platform, as a matchmaker for the dating account. For example, as illustrated in FIG. 2, a media module 212 may receive, from user 206 who has a dating account 214 with a dating application 210 maintained by social media platform 208, user input 216 designating a contact 218 of user 206, connected to user 206 via social media platform 208, as a matchmaker for dating account 214.

Dating application 210 may generally represent any type or form of user application that connects users with a dating service. In some examples, dating application 210 may represent a dedicated dating application. In other examples, dating application 210 may represent a general social media application that enables access to multiple social media services (e.g., two or more of the social media services described previously) including a dating service. In both examples, dating application 210 may operate as part of social media platform 208.

Contact 218 may represent an additional user of an additional user device (e.g., user device 220), who (1) is also a member of a platform to which user 206 is a member and (2) has been designated (e.g., added) as a contact (e.g., a friend) of user 206 within that platform. In some examples, the platform (within which contact 218 and user 206 are connected) may represent the dating service corresponding to dating application 210. In other examples (e.g., examples in which the dating service is hosted by social media platform 208), the platform (within which contact 218 and user 206 are connected) may represent social media platform 208 and/or another service of social media platform 208. In these examples, user 206 may be enabled to designate, as matchmakers, contacts who are not users of dating application 210 (e.g., friends who do not have dating accounts with dating application 210).

Media module 212 may receive user input 216 in a variety of contexts. In some examples, media module 212 may receive user input 216 via a matchmaker-selection interface (e.g., provided and accessed via dating application 210) that enables user 206 to select one or more matchmakers. In one example, the matchmaker-selection interface may be provided within a dating profile center of dating application 210 that enables user 206 to control user 206's dating profile. In some examples, the matchmaker selection interface may provide user 206 with a list of contacts of user 206 and enable user 206 to select from the list of contacts. In one example, this list may represent a list of contacts of user 206 within a dating service corresponding to dating application 210. In another example, this list may represent a list of contacts of user 206 within social media platform 208 (e.g., a platform that maintains the dating service).

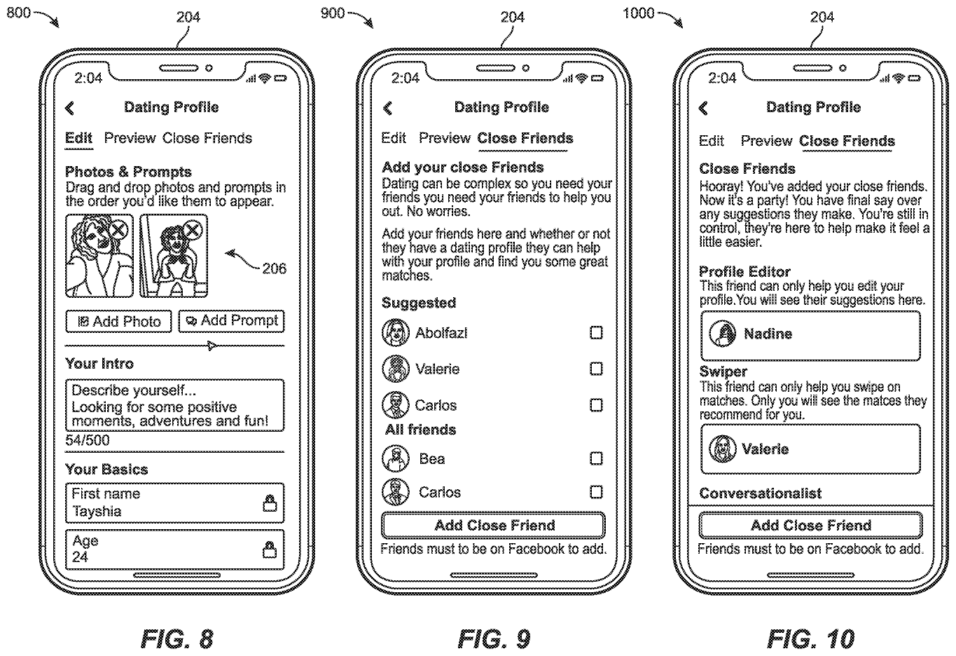

FIGS. 8-10 depict exemplary interfaces 800, 900, and 1000 of a dating profile center configured for user 206. The dating profile center may enable user 206 to manage user 206's profile via a profile interface 800 (as shown in FIG. 8) and/or manage user 206's matchmakers via a matchmaker selection interface 900 and/or a matchmaker manager interface 1000 (as shown in FIGS. 9 and 10). As shown in FIG. 9, a matchmaker selection interface may provide user 206 with a list of selectable entries, each entry corresponding to a different contact whom user 206 may designate as a matchmaker for user 206's dating account 214. In the embodiment depicted in FIG. 9, user input 216 may represent input selecting a selectable entry corresponding to contact 218.

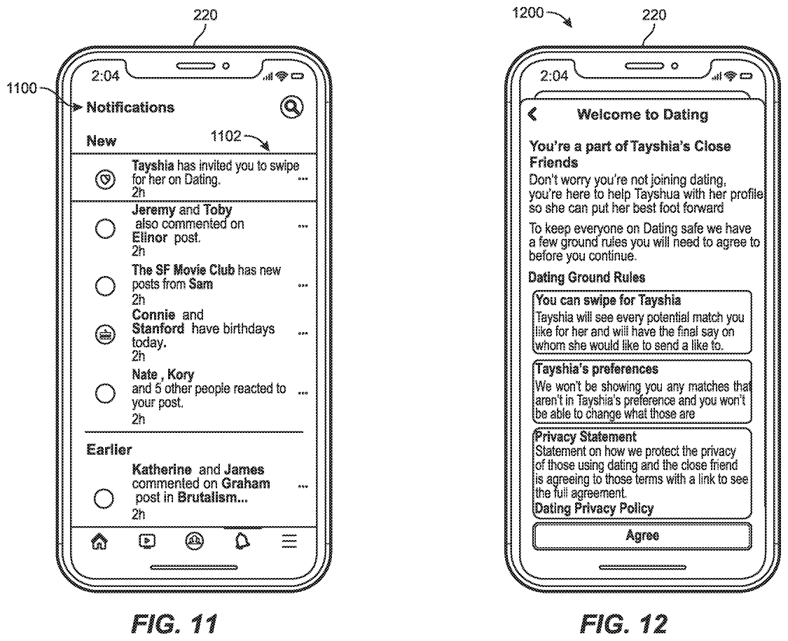

In some examples, at the time user input 216, designating contact 218 as a matchmaker, is received, contact 218 may have an account with social media platform 208 but not an account with dating application 210. In these examples, media module 212 may, in response to receiving user input 216, create, for contact 218, a matchmaker account 215 with dating application 210. In one such example, media module 212 may (1) present a notification to contact 218 indicating that contact 218 has been designated as a matchmaker for dating account 214, (2) digitally invite contact 218 to create a matchmaker account with dating application 210, and (3) create the matchmaker account in response to receiving user input from contact 218 selecting to create the matchmaker account. FIG. 11 depicts an exemplary notification page 1100 with a notification 1102 notifying contact 218 of having been added a matchmaker to user 206's dating account 214. FIG. 12 depicts an exemplary registration interface 1200 enabling contact 218 to set up a matchmaker account with dating application 210.

In response to receiving user input from contact 218 setting up a matchmaker account, media module 212 may grant contact 218 with limited matchmaker access to user 206's dating account 214 (as will be discussed in greater detail in connection with step 120). The matchmaker account may differ from a dater account. For example, the matchmaker account may enable contact 218 to perform certain digital matchmaking actions but not connect contact 218 with potential dating matches.

In some examples, the disclosed matchmaker-designation flow may enable user 206 to assign a specific matchmaker role to a contact (e.g., contact 218) that user 206 is designating as a matchmaker. For example, matchmaker manager interface 1000 in FIG. 10 may enable user 206 to assign a specific matchmaker role to a contact (e.g., contact 218). Exemplary matchmaker roles that may be selected by user 206 may include a match-selection role (e.g., a swiper role) that enables a matchmaker to conditionally accept or reject a recommended dating match for user 206, a conversationalist role that enables a matchmaker to conditionally enter messages for a recommended dating match on behalf of user 206, and/or a profile editor role that enables a matchmaker to conditionally edit a dating profile of user 206 maintained by dating application 210.

In these examples, media module 212 may receive, from user 206, additional user input assigning, to contact 218, a designated matchmaker role (e.g., a match-selection role, a conversationalist role, and/or a profile editor role) that corresponds to one or more role-specific digital matchmaking actions (e.g., conditionally accepting and/or rejection matches, entering conditional messages, and/or making conditional edits to a dating profile). In some examples, user 206 may have multiple contacts designated as matchmakers and may assign different roles to different contacts (e.g., each contact may have a different role). In some examples, user 206 may assign multiple roles to a contact. In other examples, user 206 may only be enabled to assign one role to a contact and/or may only assign one contact to each role.

Returning to FIG. 1, at step 120, one or more of the systems described herein may (in response to receiving the user input from the user) provide the contact with access to a recommended-matches interface of the dating application, with a queue of recommended dating matches (e.g., platform-recommended dating matches) selected for the user, in a matchmaker mode that enables the contact to perform one or more digital matchmaking actions. For example, as illustrated in FIG. 2, media module 212 may (in response to receiving user input 216) provide contact 218 with access to a recommended-matches interface 222 of dating application 210, with a queue of recommended dating matches 224 selected for user 206, in a matchmaker mode that enables contact 218 to perform one or more digital matchmaking actions.

Contact 218 may be enabled to perform a variety of different matchmaking actions in the matchmaker mode (e.g., in response to being designated as a matchmaker for dating account 214). Exemplary matchmaking actions will be described shortly (e.g., as part of the description of recommended-matches interface 222). In examples in which user 206 assigns a specific role to contact 218 (i.e., a role that corresponds to one or more role-specific digital matchmaking actions), the one or more digital matchmaking actions enabled in the matchmaker mode may correspond to the role-specific digital matchmaking actions. In these examples, the digital matchmaking actions enabled in the matchmaker mode for contact 218 may differ from the digital matchmaking actions enabled in the matchmaker mode for another contact designated by user 206 with a different role.

Recommended-matches interface 222 may generally represent an interface, with any visual configuration, that presents a queue of recommended dating matches 224 selected for user 206. The term “recommended dating match” may refer to an additional user (e.g., with a dating profile) selected (e.g., by a recommended match selection system maintained by social media platform 208) for user 206. In some examples, each recommended dating match may be presented within a digital profile card. FIGS. 13 and 15 depict an exemplary embodiment in which recommended-matches interface 222 presents one profile card at a time.

Recommended-matches interface 222 may provide a variety of features and enable a variety of digital user actions. As mentioned above, recommended-matches interface 222 may be presented in a primary dater mode (e.g., as depicted in FIG. 13) when presented to user 206 (i.e., the user for whom recommended dating matches 224 have been selected) and in a matchmaker mode (e.g., as depicted in FIG. 15) when presented to contact 218 (i.e., a contact of user 206 designated as a matchmaker for dating account 214). Which features are provided and/or which actions are enabled via recommended-matches interface 222 may depend on whether recommended-matches interface 222 is being presented in the matchmaker mode (e.g., to contact 218) or the primary dater mode (i.e., to user 206).

For example, when presented to user 206 in a primary dater mode, recommended-matches interface 222 may enable user 206 to accept or reject a recommended dating match (e.g., definitively). Turning to FIG. 13 to provide an exemplary depiction of this example, recommended-matches interface 222 in a primary dater mode may present a profile card 1300, corresponding to a recommended dating match selected for user 206, that includes an accept-match element 1302 and a reject-match element 1304. When recommended-matches interface 222 is presented in the primary dater mode, a user selection of reject-match element 1304 may trigger media module 212 to remove the recommended dating match from user 206's queue of recommended matches. A user selection of accept-match element 1302 may trigger a variety of events. For example, if the additional user corresponding to the recommended dating match has also accepted user 206 as a recommended dating match, user 206's selection of accept-match element 1302 may trigger a notification of the mutual accepting to be sent to user 206 and/or the additional user, may trigger messaging between user 206 and the additional user to be enabled, etc.

When recommended-matches interface 222 is presented to contact 218 in the matchmaker mode, instead of enabling contact 218 to definitively accept or reject a recommended dating match, recommended-matches interface 222 may enable contact 218 to conditionally accept or reject a recommended dating match. Turning to FIG. 15 to provide an exemplary depiction of this example, recommended-matches interface 222 may present a profile card 1500, corresponding to a recommended dating match, that includes a conditional-accept-match element 1502 and a conditional-reject-match element 1504. When recommended-matches interface 222 is presented in the matchmaker mode, a user selection to accept or reject a match may trigger media module 212 to notify user 206 of contact 218's conditional accepting or rejecting of the match (e.g., but may not trigger media module 212 to accept or reject the match without additional input from user 206).

FIGS. 13 and 15 illustrate an embodiment in which a profile card includes a first selectable element for accepting a recommended match and a second selectable element for rejecting a recommended match. In the embodiment illustrated in FIGS. 13 and 15, the visual configuration of these two elements in the primary dater mode differs from the visual configuration of the two elements in the matchmaker mode (e.g., a different graphic is used depending on the mode). While FIGS. 13 and 15 focus on an embodiment in which a user is enabled to accept or reject a match by selecting a selectable element, the disclosed dating framework may enable digital accepting or rejecting in a variety of ways. For example, the disclosed dating framework may enable a user to accept a recommended match by performing a first digital gesture (e.g., swiping in a first direction) and to reject a recommended match by performing a second digital gesture (e.g., swiping in a second direction).

Media module 212 may notify user 206 of contact 218's conditional accepting or rejecting in a variety of ways. In some examples, a notification may appear (e.g., within a notifications menu associated with dating application 210). Additionally or alternatively, a notification of contact 218's conditional accepting or rejecting of a recommended dating match may appear within the recommended dating match's profile card when the profile card is presented to user 206 within recommended-matches interface 222. Turning to FIG. 13 as a specific example in which contact 218 is named Valerie, the profile card of a recommended dating match that has been conditionally accepted by contact 218 may be presented with a digital banner that includes text such as “Valerie Liked” and/or “Valerie Recommended.” (Though not depicted, a conditional rejecting may similarly be presented within a banner that includes text such as “Skipped by Valerie”). In some embodiments (e.g., in which user 206 has designated multiple matchmakers), a conditional accepting and/or rejecting of a recommended dating match by a matchmaker may also appear within a profile card in the matchmaker view.

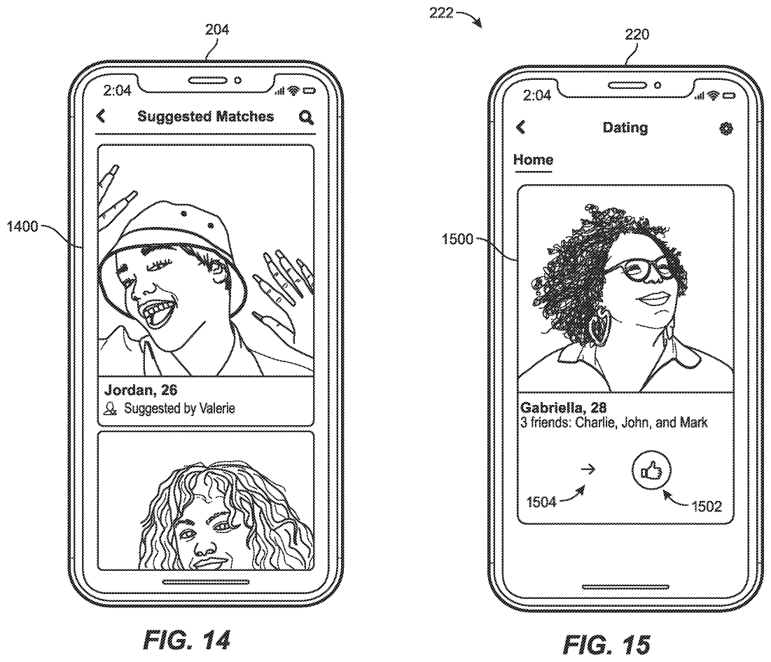

In some examples, media module 212 may create, for user 206, a digital matchmaker-accepted digest of recommended dating matches that have been accepted by contact 218 (e.g., and any other contact designated by user 206 as a matchmaker with swiping rights). Media module 212 may present the digest to user 206 via an interface of dating application 210. FIG. 14 provides a depiction of an exemplary digest interface 1400 that presents the profile cards of dating matches accepted by user 206's designated matchmakers in a vertically scrollable display.

Beyond enabling contact 218 to conditionally accept or reject a recommended match, in some examples recommended-matches interface 222, when presented to contact 218 in the matchmaker mode, may enable contact 218 to provide digital feedback relating to a recommended dating match for user 206. For example, recommended-matches interface 222 may enable contact 218 to digitally annotate a profile of a recommended dating match. As a specific example, recommended-matches interface 222 may include, in association with a recommended dating match (e.g., proximate a profile card of the recommended dating match), a text input element and/or a menu of digital content (e.g., emojis, GIFs, etc.) that contact 218 may apply to the recommended match for user 206's digital consumption. Additionally or alternatively, recommended-matches interface 222 may provide and/or enable the creation of a chat thread in association with a recommended dating match (e.g., enabling a digital conversation between user 206 and contact 218 that is digitally associated with the recommended match). In these examples the digital chat thread may be accessible via a profile card of the recommended dating match (e.g., presented in response to a user selection of a chat thread element provided within the profile card and/or a designated gesture applied to the profile card such as swiping in a designated direction).

In one embodiment (e.g., in which user 206 has assigned a conversationalist matchmaker role to contact 218), media module 212 may (1) present, to contact 218, a chat thread interface configured for messaging between user 206 and a recommended dating match (e.g., a mutual match) and (2) enable contact 218 to conditionally submit a message to the chat thread. Additionally or alternatively (e.g., in an embodiment in which user 206 has assigned a profile editor matchmaker role to contact 218), media module 212 may (1) present, to contact 218, a dating profile of user 206 and (2) enable contact 218 to conditionally edit the dating profile.

In response to receiving input to user 206's dating account 214 from contact 218 (while contact 218 is accessing dating account 214 in the matchmaker mode), media module 212 may present the input to user 206 (e.g., for user 206's consumption and/or approval). For example, media module 212 may present to user 206 (e.g., within recommended-matches interface 222) a conditional acceptance or rejection selected by contact 218 for a recommended dating match (as described earlier), one or more annotations applied, by contact 218, to a recommended dating match, and/or a chat thread (corresponding to a recommended dating match) with one or more messages conditionally submitted by contact 218.

In some examples, recommended-matches interface 222 (when presented to user 206 in the primary-dater mode) may include one or more features that enable user 206 to request input (e.g., a second opinion from a friend) for a specific recommended dating match. As a specific example, recommended-matches interface 222 (presented to user 206 in the primary-dater mode) may provide, within a profile card for a recommended dating match, (1) a first element configured to accept the recommended dating match when selected via a first type of user input and (2) a second element configured to reject the recommended dating match when selected via the first type of user input. Using FIG. 16 as a specific example, recommended-matches interface 222 may present a profile card 1600 for a recommended dating match with a first selectable element 1602 and a second selectable element 1604. Media module 212 may be configured to (1) accept the recommended dating match if a first type of user input is applied to first selectable element 1602 (e.g., a single tap to an area of a touchscreen corresponding to first selectable element 1602) and (2) reject the recommended dating match if the first type of user input is applied to second selectable element 1604 (e.g., a single tap to an area of a touchscreen corresponding to second selectable element 1604).

In this specific example, the first selectable element and/or the second selectable element (e.g., first selectable element 1602 and/or second selectable element 1604 in FIG. 16) may be configured to initiate a vibe check process when selected via a second type of user input (e.g., a long press applied to a portion of a touchscreen corresponding to first selectable element 1602 and/or to second selectable element 1604) instead of the first type of user input being applied. The vibe check process may represent any type or form of digital flow that includes (1) sending a request to a contact of user 206 for digital feedback relating to a particular recommended dating match and/or (2) digitally sharing the requested digital feedback (submitted by the contact in response to the request) with user 206. In some examples, the vibe check process may include (1) enabling user 206 to select one or more contacts from whom to request digital feedback (e.g., as exemplarily depicted in interface 1606 of FIG. 16) and (2) transmitting a profile card for the particular recommended dating match to the one or more selected contacts.

In some examples, the vibe check process may be integrated with the matchmaker framework described herein. In these examples, the matchmaker framework may include enabling user 206 to request a vibe check from designated matchmakers. Additionally or alternatively, the vibe check process may enable user 206 to send a request for digital feedback to any contact of user 206 (e.g., any contact connected to user 206 within social media platform 208 and/or any contact connected to user 206 within a dedicated dating service corresponding to dating application 210).

The vibe check process may transmit the profile card (of a recommended dating match for whom user 206 has requested a vibe check) to a selected contact in a variety of ways. In some examples, the profile card may be transmitted to the contact via a messaging thread (e.g., via a digital chat as exemplarily depicted in interface 1606 of FIG. 16). In other examples (e.g., in which the profile card is transformed into a story, as will be described shortly), the profile card may be added to a series of stories configured for the contact (i.e., to be consumed via a stories service of social media platform 208). In some examples, the profile card may be transmitted to a contact by sending the contact a link to the profile card. When selected, the profile card may surface (e.g., in a matchmaker mode that enables one or more of the matchmaking actions described above).

In certain examples, initiating a vibe check process for a recommended dating match may trigger media module 212 to (1) generate (e.g., automatically) a private ephemeral story that includes content from the recommended dating match's profile card and (2) share the private ephemeral story with a contact selected by user 206. The contents of recommended dating match's profile card may be used to generate an ephemeral story in a variety of ways. In some examples, photos from the profile card may be extracted from the profile card and added to the ephemeral story in a slideshow format and/or a collage format. Additionally or alternatively, text from the profile card may be extracted from the profile card and added to the ephemeral story. For example, the text may be superimposed over a photo and/or collage of photos. As another example, the text may be added to a text card and added to a slideshow of photos presented as part of the ephemeral story. FIG. 17 depicts an exemplary story interface 1700 with an automatically generated ephemeral story generated for a recommended match, selected for user 206, for whom user 206 has requested a vibe check.

In some examples (as depicted in FIG. 17), the automatically generated ephemeral story may be configured to include a poll (e.g., that enables viewers to vote on whether the recommended match highlighted in the ephemeral story is a good match for user 206). In these examples, the disclosed vibe check process may (1) enable the contacts (selected by user 206 for a vibe check) to vote on the profile card and (2) present the results of the voting to user 206. FIG. 17 depicts an embodiment in which voting results are presented to user 206 (and the contacts invited to view the ephemeral story) via a messaging thread 1702.

The ephemeral story may be configured as a private story in a variety of ways. For example, the ephemeral story may be transmitted to the one or more contacts selected by user 206 but resharing of the story by the one or more contacts may be disabled. In some examples, a vibe check process may only be initiated for recommended dating matches who have permitted vibe check sharing (e.g., by selecting to permit vibe check sharing via a privacy interface presented to the recommended dating matches).

In some examples, the disclosed dating framework may maintain a shared streaming space that enables user 206 and one or more additional users to co-view one or more interfaces of user 206's dating account 214. The term “shared streaming space” may refer to any type or form of media conferencing room (e.g., with one or more of the media conferencing features discussed previously) that enables a group of users to co-view an interface of user 206's dating account 214. FIG. 18 provides an exemplary depiction of a shared streaming space 1800 in which recommended-matches interface 222 is presented in a primary viewing pane of a streaming interface and a ribbon of user tiles (each corresponding to a different video stream of a different user participating in shared streaming space 1800) presented above the primary viewing pane.

In some embodiments, shared streaming spaces may be integrated with dating application 210. In one such embodiment, a shared streaming space for dating account 214 may be persistently maintained and accessible via dating application 210 (e.g., within a persistent “Digital Matchmaker Hub” accessed via a “Date Together” element provided within an interface of dating application 210).

In some embodiments, a shared streaming space may be provided as part of the matchmaker framework disclosed herein. In one such embodiment, a shared streaming space may automatically be generated for user 206 and user 206's designated matchmakers (e.g., in response to user 206 creating dating account 214 and/or adding a matchmaker to dating account 214). In other embodiments, user 206 may be permitted to invite any contact or user to join a shared streaming space corresponding to dating account 214. In some examples, user 206 may be enabled to create multiple shared streaming spaces (e.g., each corresponding to a different group of user 206's contacts).

In some examples, as suggested above, a shared streaming space, configured for dating account 214, may enable participating users to co-view recommended-matches interface 222 (e.g., co-viewing various matches presented within recommended-matches interface 222). In some examples, the shared streaming space may be configured to only enable subset of the interfaces of user 206's dating account to be presented for co-viewing. For example, the shared streaming space may only enable co-viewing of recommended-matches interface 222. In another such example, which interfaces may be presented within the shared streaming space may be selected by user 206 in real time during a co-viewing session.

In some examples, a shared streaming space, configured for dating account 214, may (1) provide user 206 with navigational control by default and (2) enable user 206 to transfer the navigational control to another user participating in the shared streaming space. In one such example, the shared streaming space may visually indicate which user currently has navigational control by presenting, as a dynamic cursor element within the shared streaming space, a profile image corresponding to the user who has navigational control. FIG. 18 depicts an exemplary cursor element 1802 that includes a profile image of a user with navigational control at the center of the cursor element. In some examples, user 206 may have different (e.g., elevated) control than other users given navigational control. For example, user 206 may have control to accept or reject recommended matches but other users may only have control to conditionally accept or reject recommended matches. In one embodiment, user 206 may assign different levels of control to another user to whom user 206 has given navigational control (e.g., providing the other user with full control and/or limited control).

In one embodiment, media module 212 may enable participating users to submit digital reactions to an interface (and/or a profile card provided within an interface) being presented within a shared streaming space. In some such embodiments, the shared streaming space may enable a participating user to (1) select a particular location within an interface being presented within the shared streaming space and (2) select a digital reaction to affix to the particular location. In one such embodiment, media module 212 may receive, from a user participating in a shared streaming space, a long-press applied to a particular spatial location within an interface being presented within the shared streaming space. In response, media module 212 may present (to a view of the interface configured for the user who applied the long-press, at the particular spatial location) a digital reaction wheel with multiple digital reactions that may be selected by the user (e.g., a heart emoji, a 100% graphic, a thumbs up emoji, etc.). In response to receiving, from the user, a selection of a digital reaction from the reaction wheel, media module 212 may apply (to a view of the shared streaming space configured for one or more of the other users participating in the shared streaming space) a digital reaction corresponding to the selected reaction. FIG. 19 provides an exemplary depiction of a digital reaction wheel 1900 being presented to a user and digital feedback selected via digital reaction wheel 1900 being presented within the shared streaming space.

In some examples, media module 212 may automatically generate a private playback composition summarizing a co-viewing session and/or a portion of a co-viewing session within a shared streaming space. In one such example, media module 212 may (1) automatically capture a series of snapshots of the shared streaming space while a profile card of a particular recommended match is being viewed via the shared streaming space (e.g., snapshots of user video streams being streamed via the shared streaming space), (2) automatically generate a private story with the automatically captured snapshots, and (3) present the private story to one or more of the users participating in the shared streaming space. In some examples, the private story may be stored in connection with the profile card. In these examples, an interface (such as recommended-matches interface 222 and/or a match-history interface) may include, in connection with the profile card, a selectable playback element that, when selected, surfaces the private story. In addition (or as an alternative to) generating a story with the snapshots of the shared streaming space, in some examples, the snapshots may be presented (e.g., to user 206 and/or the users participating in the co-viewing session) as a scrollable set of images (e.g., accessible via a selectable playback element).

User interfaces corresponding to the methods and systems described above may be surfaced as part of a variety of navigational flows. In some examples, a navigational flow may include a combination of user interfaces described herein and additional user interfaces not described herein. Each user interface described herein may be surfaced from a variety of entry points. In some examples, the user interfaces described here may be interconnected (e.g., with one interface navigating to another).

The description of the steps of FIG. 1 above makes frequent mention of contact 218 performing conditional actions. In some examples, an action may be “conditional” if (1) the action is a trigger for an event but (2) the event requires approval by user 206 to be effectuated. In examples involving a conditional action, (1) contact 218 performing the conditional action may trigger the conditional action to be presented to user 206 and (2) user 206 digitally accepting the conditional action may trigger the event to be effectuated.

As a specific example, contact 218 submitting a conditional message to a chat thread between user 206 and a dating match of user 206 (a conditional action) may trigger the message to be presented to user 206. Then, user 206 accepting the conditional message (e.g., by performing a designated gesture such as double tapping the message and/or by selecting a selectable approval element visually associated with the conditional message) may trigger the message to be sent to the dating match (the event).

As another specific example, contact 218 conditionally accepting or rejecting a recommended dating match (a conditional action) may trigger the conditional accepting or rejecting to be presented to user 206. Then, user 206 accepting the conditional accepting or rejecting of the dating match (e.g., by performing a digital accepting or rejecting action) may trigger the recommended dating match to be accepted or rejected (the event).

As another specific example, contact 218 conditionally editing a dating profile of user 206 (a conditional action) may trigger the conditional edit to be presented to user 206. Then, user 206 accepting the conditional accepting or rejecting of the conditional edit (e.g., by performing a designated gesture and/or by selecting a selectable approval element) may trigger the conditional edit to be applied to the dating profile of user 206 (the event). In certain embodiments, user 206 may determine whether to give a matchmaker conditional rights or definitive rights (e.g., via a matchmaker management interface).

In the embodiments depicted in the figures herein (e.g., FIGS. 3-19), the exemplary interfaces have been optimized for a mobile device. Additional or alternative embodiments of these exemplary interfaces may be optimized for other types of computing devices (e.g., a desktop computer, a laptop computer, a wearable device, etc.). In some examples, some or all of the content of these interfaces maybe dynamically modified (e.g., customized for a particular user). For example, posts within a social media feed may be dynamically selected (e.g., based on a variety of inputs, as will be described in greater detail below).

Each of the computer-mediated actions described herein may be performed by a module (e.g., media module 212) that operates within an endpoint device (e.g., user device 204 and/or user device 220) and/or that operates within a backend server (e.g., server 202). In the examples in which an action involves presenting digital content to a user via an endpoint device and/or receiving user input and/or digital feedback from the user to the endpoint device, the module may perform the action directly, in examples in which the module operates within the endpoint device (e.g., by displaying content via a display element of the endpoint, receiving tapping input to a touchscreen of the endpoint device, and/or receiving input to an auxiliary device communicatively coupled to the endpoint device such a digital mouse and/or a keyboard), and/or indirectly (e.g., in examples in which the module operates within the server). In examples in which a module performs an action indirectly, the module may perform the action in a variety of ways. For example, the module may perform the action by instructing the endpoint device to perform the action, by transmitting content to the endpoint device to be presented by the endpoint device, by providing the endpoint with an application (e.g., dating application 210) that performs the action, by receiving an indication of user input to the endpoint device from the endpoint device, etc. Additionally, in some examples, the module may perform an action operating in a combination of an endpoint device and a backend server.

Each of the digital actions described above may be performed in conjunction with a permissions framework (e.g., a data privacy framework) that enables a user to select how data is selected for the user, how data relating to the user is collected, and how data relating to the user is shared with other users. In some examples, user 206 may provide permission for an action via a digital permissions process (e.g., via input to a permissions menu and/or page). In some examples, the digital permissions process may be directed to selecting an audience for a user generated post. Additionally or alternatively, the digital permissions process may be directed to permitting information about the user (e.g., a status and/or availability) to be broadcast (e.g., within a profile element and/or contact list). As another example, the digital permissions process may be directed to collecting user history (e.g., to apply to a machine learning system used to select content for the user).

In some of the embodiments described above, the disclosed systems may enable a user to create content (e.g., a social media post for a social media feed and/or a digital message for a private digital messaging thread) via a content-creation interface (e.g., a profile editor interface and/or a matchmaker feedback interface). In these embodiments, the content-creation interface may enable a content creation that includes a variety of types of content. Such content may include, without limitation, an image, a video, audio content, a graphic (e.g., a digital sticker), a special effect (e.g., an augmented reality effect), a filter, etc.

The content-creation interface may enable a user to provide content (e.g., for a digital composition such as a post and/or message) in a variety of ways. In some examples, the content-creation interface may enable a user to create (e.g., generate) content via the content-creation interface. For example, the content-creation interface may include a digital canvas that enables a user to digitally draw content and/or may include a capture screen that enables the user to capture visual content via a camera of the user's device and/or audio content via a microphone of the user's device. As another example, the content-creation interface may include a text-input box that enables the user to input text (e.g., via typing input). Additionally or alternatively, the content-creation interface may enable the user to upload content. For example, the content-creation interface may include a drag-and-drop functionality and/or may present content (e.g., images stored in a camera roll of the user's device where permission to access the images has been provided) that may be selected to be included in the user's content creation. In addition to enabling a user to provide (e.g., create and/or upload) content, the content-creation interface may enable a user to modify (e.g., customize) content. For example, the content-creation interface may include a text-customization feature that enables a user to customize the appearance of text (e.g., selecting a size, color, font, and/or position of text). As another example, the content-creation interface may enable a user to select a filter and/or special effect to be applied over content.

In some of the embodiments described above, a module (e.g., media module 212) may select content for user 206. For example, a module may select social media consumption content for user 206 (e.g., a social media composition for a social media feed and/or a social media feed relating to a particular topic or theme) and/or suggested additional users for user 206 (e.g., users to add as matchmakers, users within whom to co-view an interface of a dating account, a recommended dating match, etc.). In these embodiments, the module may select content for user 206 in a variety of ways. For example, social media consumption content may be selected based on a relationship between user 206 and a creator of the social media consumption content (e.g., in response to determining that the creator is a contact of user 206 and/or that user 206 is following the creator), a user history and/or demographic of user 206 (e.g., indicative of a user interest), user data relating to a contact of user 206 and/or users with a features in common with user 206, etc. As another example, an additional user may be selected for user 206 based on a relationship between user 206 and the additional user (e.g., a relationship claimed by user 206 within social media platform 208, a number of social connections between user 206 and the additional user such as a number of mutual contacts, and/or a metric relating to an amount of digital interaction between user 206 and the additional user within social media platform 208), a common interest identified between user 206 and the additional user, a common age range between user 206 and the additional user, a common geographic area between user 206 and the additional user (e.g., a common current location and/or a common hometown), etc.

In some examples, content may be selected for user 206 by a machine learning system (e.g., a neural network). In these examples, the machine learning system may select the content in response to receiving a variety of inputs. Such inputs may include inputs relating to user 206 (e.g., an input derived from a user history, an expressed user preference, etc.), inputs relating to users with a features in common with user 206, inputs relating to a demographic and/or a region associated with user 206, inputs derived from a social graph, inputs relating to potential content that may be selected for user 206 (e.g., a topic of such content and/or a popularity of such content), etc.

### Example Embodiments

Example 1: A computer-implemented method may include (1) receiving, from a user who has a dating account with a dating application maintained by a social media platform, user input designating a contact of the user, connected to the user via the social media platform, as a matchmaker for the dating account and (2) in response to receiving the user input designating the contact as a matchmaker for the dating account, providing the contact with access to a recommended-matches interface of the dating application, comprising a queue of recommended dating matches selected for the user, in a matchmaker mode that enables the contact to perform one or more digital matchmaking actions.

Example 2: The computer-implemented method of example 1, where the one or more digital matchmaker actions include conditionally accepting or rejecting a recommended dating match provided within the queue of recommended dating matches.

Example 3: The computer-implemented method of examples 1-2, where the one or more digital matchmaker actions include digitally annotating a profile of a recommended dating match provided within the queue of recommended dating matches.

Example 4: The computer-implemented method of examples 1-3, where the one or more digital matchmaker actions include conditionally submitting a message to a chat thread corresponding to a recommended dating match provided within the queue of recommended dating matches.

Example 5: The computer-implemented method of examples 1-4, where the method further includes (1) providing the recommended-matches interface to the user in a primary-dater mode and (2) presenting, within the recommended-matches interface provided to the user in the primary-dater mode, a conditional acceptance or rejection selected, by the contact, for a recommended dating match, one or more annotations applied, by the contact, to a recommended dating match, and/or a chat thread, including one or more messages conditionally submitted by the contact, corresponding to a recommended dating match.

Example 6: The computer-implemented method of examples 1-5, where the method further includes creating, for the user, a digital matchmaker-accepted digest including recommended dating matches that have been accepted by one or more contacts of the user who have been designated as matchmakers.

Example 7: The computer-implemented method of examples 1-6, where (1) the method further includes receiving, from the user, additional user input assigning a designated matchmaker role to the contact, (2) the designated matchmaker role corresponds to one or more role-specific digital matchmaking actions, and (3) the one or more digital matchmaking actions enabled in the matchmaker mode correspond to the role-specific digital matchmaking actions.

Example 8: The computer-implemented method of example 7, where the designated matchmaker role includes a selection role (e.g., a swiper role) that enables a matchmaker to conditionally accept or reject a recommended dating match for the user, a conversationalist role that enables a matchmaker to conditionally enter messages for a recommended dating match on behalf of the user, and/or a profile editor role that enables a matchmaker to conditionally edit a dating profile of the user maintained by the dating application.

Example 9: The computer-implemented method of examples 1-8, where (1) at the time the user input, designating the contact as a matchmaker, is received, the contact has an account with the social media platform but does not have an account with the dating application and (2) the method further includes, in response to receiving the user input designating the contact as a matchmaker for the dating account, creating a matchmaker account for the contact with the dating application.

Example 10: The computer-implemented method of example 9, were creating the matchmaker account includes (1) presenting a notification to the contact indicating that the contact has been designated as a matchmaker for the user's dating account, (2) digitally inviting the contact to create the matchmaker account with the dating application, and (3) creating the matchmaker account in response to receiving user input from the contact selecting to create the matchmaker account.

Example 11: The computer-implemented method of examples 1-10, where the method further includes (1) providing the recommended-matches interface to the user in a primary-dater mode in which a recommended dating match is presented within a profile card that includes a first element, configured to accept the recommended dating match when selected via a first type of user input, and a second element, configured to reject the recommended dating match when selected via the first type of user input and (2) configuring at least one of the first or second element to trigger a vibe check process when selected via a second type of user input, wherein the vibe check process comprises transmitting the profile card to one or more contacts selected by the user for digital feedback.

Example 12: The computer-implemented method of example 11, where transmitting the profile card to the one or more contacts comprises transmitting the profile card to the contact designated as a matchmaker.

Example 13: The computer-implemented method of examples 11-12, where transmitting the profile card to the one or more contacts includes transmitting the profile card as an automatically generated private ephemeral story.

Example 14: The computer-implemented method of examples 11-13, where (1) (1) transmitting the profile card to the one or more contacts includes enabling the one or more contacts to vote on the profile card and (2) the method further includes presenting the voting results to the user.

Example 15: The computer-implemented method of examples 1-14, where the method further includes creating a shared streaming space that enables the user and one or more additional users to co-view an interface of the user's dating account.

Example 16: The computer-implemented method of example 15, where the shared streaming space (1) provides the user with navigational control by default, (2) enables the user to pass the navigational control to another user participating in the shared streaming space, and (3) visually indicates which user currently has navigational control by presenting, as a dynamic cursor element within the shared streaming space, a profile image corresponding to the user who has navigational control.

Example 17: The computer-implemented method of examples 15-16, where the method further includes (1) receiving, from a user participating in the shared streaming space, a long-press applied to a particular spatial location within the interface of the user's dating account, (2) in response to receiving the long-press, presenting, to a view of the interface configured for the user who applied the long-press, at the particular spatial location, a reaction wheel with multiple digital reactions that may be selected by the user who applied the long-press, (3) receiving, from the user who applied the long-press, a selection of a digital reaction from the reaction wheel, and (4) applying, to a view of the shared streaming space configured for one or more of the other users participating in the shared streaming space, a digital reaction corresponding to the selected reaction.

Example 18: The computer-implemented method of examples 15-17 where the method further includes (1) automatically capturing a series of snapshots of the shared streaming space while a profile card of a particular recommended match is being viewed via the shared streaming space, (2) automatically generating a private story comprising the automatically captured snapshots, and (3) presenting the private story to one or more of the users participating in the shared streaming space.

Example 19: A system for implementing the above-described method may include at least one physical processor and physical memory that includes computer-executable instructions that, when executed by the physical processor, cause the physical processor to (1) receive, from a user who has a dating account with a dating application maintained by a social media platform, user input designating a contact of the user, connected to the user via the social media platform, as a matchmaker for the dating account and (2) in response to receiving the user input designating the contact as a matchmaker for the dating account, provide the contact with access to a recommended-matches interface of the dating application, comprising a queue of recommended dating matches selected for the user, in a matchmaker mode that enables the contact to perform one or more digital matchmaking actions.

Example 20: A non-transitory computer-readable medium may include one or more computer-readable instructions that, when executed by at least one processor of a computing device, cause the computing device to (1) receive, from a user who has a dating account with a dating application maintained by a social media platform, user input designating a contact of the user, connected to the user via the social media platform, as a matchmaker for the dating account and (2) in response to receiving the user input designating the contact as a matchmaker for the dating account, provide the contact with access to a recommended-matches interface of the dating application, comprising a queue of recommended dating matches selected for the user, in a matchmaker mode that enables the contact to perform one or more digital matchmaking actions.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., memory devices 226, 228, and 230 in FIG. 2) and at least one physical processor (e.g., physical processors 232, 234, and 236 in FIG. 2).

The term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium” may refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, from a user who has a dating account with a dating application maintained by a social media platform, user input designating a contact of the user, connected to the user via the social media platform, as a matchmaker for the dating account; and
in response to receiving the user input designating the contact as a matchmaker for the dating account, providing the contact with access to a recommended-matches interface of the dating application, comprising a queue of recommended dating matches selected for the user, in a matchmaker mode that enables the contact to perform one or more digital matchmaking actions.

2. The computer-implemented method of claim 1, wherein the one or more digital matchmaker actions comprise conditionally accepting or rejecting a recommended dating match provided within the queue of recommended dating matches.

3. The computer-implemented method of claim 1, wherein the one or more digital matchmaker actions comprise digitally annotating a profile of a recommended dating match provided within the queue of recommended dating matches.

4. The computer-implemented method of claim 1, wherein the one or more digital matchmaker actions comprise conditionally submitting a message to a chat thread corresponding to a recommended dating match provided within the queue of recommended dating matches.

5. The computer-implemented method of claim 1, further comprising:
providing the recommended-matches interface to the user in a primary-dater mode;
presenting, within the recommended-matches interface provided to the user in the primary-dater mode, at least one of:
a conditional acceptance or rejection selected, by the contact, for a recommended dating match;
one or more annotations applied, by the contact, to a recommended dating match; or
a chat thread, comprising one or more messages conditionally submitted by the contact, corresponding to a recommended dating match.

6. The computer-implemented method of claim 1, further comprising creating, for the user, a digital matchmaker-accepted digest comprising recommended dating matches that have been accepted by one or more contacts of the user who have been designated as matchmakers.

7. The computer-implemented method of claim 1, wherein:
the method further comprises receiving, from the user, additional user input assigning a designated matchmaker role to the contact;
the designated matchmaker role corresponds to one or more role-specific digital matchmaking actions; and
the one or more digital matchmaking actions enabled in the matchmaker mode correspond to the role-specific digital matchmaking actions.

8. The computer-implemented method of claim 7, wherein the designated matchmaker role comprises at least one of:
a selection role that enables a matchmaker to conditionally accept or reject a recommended dating match for the user;
a conversationalist role that enables a matchmaker to conditionally enter messages for a recommended dating match on behalf of the user; or
a profile editor role that enables a matchmaker to conditionally edit a dating profile of the user maintained by the dating application.

9. The computer-implemented method of claim 1, wherein:
at the time the user input, designating the contact as a matchmaker, is received, the contact has an account with the social media platform but does not have an account with the dating application; and
the method further comprises, in response to receiving the user input designating the contact as a matchmaker for the dating account, creating a matchmaker account for the contact with the dating application.

10. The computer-implemented method of claim 9, wherein creating the matchmaker account comprises:
presenting a notification to the contact indicating that the contact has been designated as a matchmaker for the user's dating account;
digitally inviting the contact to create the matchmaker account with the dating application; and
creating the matchmaker account in response to receiving user input from the contact selecting to create the matchmaker account.

11. The computer-implemented method of claim 1, further comprising:
providing the recommended-matches interface to the user in a primary-dater mode in which a recommended dating match is presented within a profile card that includes a first element, configured to accept the recommended dating match when selected via a first type of user input, and a second element, configured to reject the recommended dating match when selected via the first type of user input; and
configuring at least one of the first or second element to trigger a vibe check process when selected via a second type of user input, wherein the vibe check process comprises transmitting the profile card to one or more contacts selected by the user for digital feedback.

12. The computer-implemented method of claim 11, wherein transmitting the profile card to the one or more contacts comprises transmitting the profile card to the contact designated as a matchmaker.

13. computer-implemented method of claim 11, wherein transmitting the profile card to the one or more contacts comprises transmitting the profile card as an automatically generated private ephemeral story.

14. The computer-implemented method of claim 11, wherein:
transmitting the profile card to the one or more contacts comprises enabling the one or more contacts to vote on the profile card; and
the method further comprises presenting the voting results to the user.

15. The computer-implemented method of claim 1, further comprising creating a shared streaming space that enables the user and one or more additional users to co-view an interface of the user's dating account.

16. The computer-implemented method of claim 15, wherein the shared streaming space:
provides the user with navigational control by default;
enables the user to pass the navigational control to another user participating in the shared streaming space; and
visually indicates which user currently has navigational control by presenting, as a dynamic cursor element within the shared streaming space, a profile image corresponding to the user who has navigational control.

17. The computer-implemented method of claim 15, further comprising:
receiving, from a user participating in the shared streaming space, a long-press applied to a particular spatial location within the interface of the user's dating account; and
in response to receiving the long-press, presenting, to a view of the interface configured for the user who applied the long-press, at the particular spatial location, a reaction wheel comprising a plurality of digital reactions that may be selected by the user who applied the long-press;
receiving, from the user who applied the long-press, a selection of a digital reaction from the reaction wheel; and
applying, to a view of the shared streaming space configured for one or more of the other users participating in the shared streaming space, a digital reaction corresponding to the selected reaction.

18. The computer-implemented method of claim 15, further comprising:
automatically capturing a plurality of snapshots of the shared streaming space while a profile card of a particular recommended match is being viewed via the shared streaming space;
automatically generating a private story comprising the automatically captured snapshots; and
presenting the private story to one or more of the users participating in the shared streaming space.

19. A system comprising:
at least one physical processor; and
physical memory comprising computer-executable instructions that, when executed by the physical processor, cause the physical processor to:
receive, from a user who has a dating account with a dating application maintained by a social media platform, user input designating a contact of the user, connected to the user via the social media platform, as a matchmaker for the dating account; and
in response to receiving the user input designating the contact as a matchmaker for the dating account, provide the contact with access to a recommended-matches interface of the dating application, comprising a queue of recommended dating matches selected for the user, in a matchmaker mode that enables the contact to perform one or more digital matchmaking actions.

20. A non-transitory computer-readable medium comprising one or more computer-readable instructions that, when executed by at least one processor of a computing device, cause the computing device to:
receive, from a user who has a dating account with a dating application maintained by a social media platform, user input designating a contact of the user, connected to the user via the social media platform, as a matchmaker for the dating account; and
in response to receiving the user input designating the contact as a matchmaker for the dating account, provide the contact with access to a recommended-matches interface of the dating application, comprising a queue of recommended dating matches selected for the user, in a matchmaker mode that enables the contact to perform one or more digital matchmaking actions.
